(19) United States
(12) Patent Application Publication
(10) Pub. No.: US 2009/0219788 A1
(43) Pub. Date: Sep. 3, 2009

(54) Combination watch and cell phone foldable onto each other for use around a wrist of a user

(76) Inventor: Horace Henley, JR., Bastrop, TX (US)

Correspondence Address: RICHARD L. MILLER, 12 PARKSIDE DRIVE, DIX HILLS, NY, 11746, US

(21) Appl. No.: 12/074,491

(22) Filed: Mar. 3, 2008

(51) Int. Cl. G04B 47/00; H04M 1/00

(52) U.S. Cl. 368/13; 455/556.1

(57) ABSTRACT

A combination watch and cell phone foldable onto each other for use around a wrist of a user. The combination includes a watch, a cell phone, a band, and apparatus selectively maintaining the watch and the cell phone folded against each other and the band. The band is engages around the wrist of the user. The watch is operatively connected to the band so as to form a wristwatch. The cell phone is operatively connected to the band.

### 1. BACKGROUND OF THE INVENTION

A. Field of the Invention

The embodiments of the present invention relate to a watch for use around a wrist of a user, and more particularly, the embodiments of the present invention relate to a combination watch and cell phone foldable onto each other for use around a wrist of a user.

B. Description of the Prior Art

Numerous innovations for wrist-related devices have been provided in the prior art. Even though these innovations may be suitable for the specific individual purposes to which they address, however, they differ from the embodiments of the present invention in that they do not teach a combination watch and cell phone foldable onto each other for use around a wrist of a user.

(1) U.S. Pat. No. 3,032,651 to Gisiger-Stähli et al.

U.S. Pat. No. 3,032,651 issued to Gisiger-Stähli et al. on May 1, 1962 in class 250 and subclass 14 teaches a radio set including a wrist watch casing, a pair of hollow supporting clips symmetrically and pivotably attached to the casing, a plurality of radio set components located in the casing and in the hollow clips, and conductive apparatus electrically connecting the components in the casing and the components in the hollow clips. The components include a loud speaker, a current source, and an antenna located in the hollow clips.

(2) U.S. Pat. No. 5,214,623 to Seager.

U.S. Pat. No. 5,214,623 issued to Seager on May 25, 1993 in class 368 and subclass 10 teaches a combined wristwatch and radiotelephone, having a plurality of substantially rigid link members disposed side by side in a series. Adjacent link members in the series are pivotally connected to one another about pivotal axes, all of which are substantially parallel to one another and to the longitudinal axis of the user's wrist when the apparatus is worn as a wristwatch. A main body member, which may contain or include such components as a display and a telephone dialing keypad, is disposed at an intermediate location in the series. An end member is disposed at each end of the series. One end member contains a radiotelephone microphone, and the other end member contains a radiotelephone speaker. A mechanism is associated with the series of link members for causing the link members to pivot relative to one another so that the apparatus can be placed in either a curved wristwatch configuration or a more elongated radiotelephone configuration.

(3) U.S. Pat. No. 5,381,387 to Blonder et al.

U.S. Pat. No. 5,381,387 issued to Blonder et al. on Jan. 10, 1995 in class 368 and subclass 10 teaches a radiotelephone device, including a case including a transceiver. A multilayer strap is attached to the case for fastening the device to a user's wrist. The multilayer strap has a top layer and a bottom layer. A microphone is electrically connected to the transceiver. A speaker is located at an end of the top layer of the strap and electrically connected to the transceiver. The speaker is located in a housing having a first surface substantially parallel to the top layer of the strap, and at least one other surface integrally connected to the first surface, which is positioned at an angle with respect to the first surface. At least one sound port is located within the at least one other surface of the housing.

(4) U.S. Pat. No. 6,035,035 to Firooz.

U.S. Pat. No. 6,035,035 issued to Firooz on Mar. 7, 2000 in class 379 and subclass 433 teaches a wrist-mounted telephone device for attaching to the wrist of a wearer and including a cellular telephone mechanism and a battery power source that are separately mounted in a common housing.

(5) U.S. Pat. No. 6,314,184 to Fernandez-Martinez.

U.S. Pat. No. 6,314,184 issued to Fernandez-Martinez on Nov. 6, 2001 in class 379 and subclass 433.1 teaches a mobile telephone apparatus/wireless telephone terminal mounted in a fixed or removable way to a bracelet support having a portion wherein are housed electric supply batteries for supplying power to the device. The telephone apparatus has a front panel with keyboard, presentation display, and microphone. The apparatus has preferably its larger dimension oriented obliquely with respect to the longitudinal direction of the bracelet. A ring-shape part intended to be coupled to one finger of the user hand is removable with respect to the apparatus and supports an earphone for the apparatus to which it is connected by an extensible electric cable or by radio.

(6) U.S. Pat. No. D460,430 to Wada et al.

U.S. Pat. No. D460,430 issued to Wada et al. on Jul. 16, 2002 in class D14 and subclass 138 teaches the ornamental design for a mobile phone.

(7) U.S. Pat. No. 6,549,791 to Jeon et al.

U.S. Pat. No. 6,549,791 issued to Jeon et al. on Apr. 15, 2003 in class 455 and subclass 572 teaches a watch type portable radiotelephone. The watch type portable radiotelephone includes a body element having upper and lower case frames, a battery pack holder including a battery pack for supplying power to the body element, a locking device for locking and unlocking the battery pack to and from the battery pack holder, respectively, a hinge connector for rotatably connecting the body element and the battery pack holder to each other, and a wrist band connected to the body element and the battery pack holder for enabling the portable radiotelephone to be worn around the wrist.

It is apparent that numerous innovations for wrist-related devices have been provided in the prior art that are adapted to be used. Furthermore, even though these innovations may be suitable for the specific individual purposes to which they address, however, they would not be suitable for the purposes of the present invention as heretofore described, namely, a combination watch and cell phone foldable onto each other for use around a wrist of a user.

### 2. SUMMARY OF THE INVENTION

Thus, it is an object of the embodiments of the present invention to provide a combination watch and cell phone foldable onto each other for use around a wrist of a user, which avoids the disadvantages of the prior art.

Briefly stated, another object of the embodiments of the present invention is to provide a combination watch and cell phone foldable onto each other for use around a wrist of a user. The combination includes a watch, a cell phone, a band, and apparatus selectively maintaining the watch and the cell phone folded against each other and the band. The band is engages around the wrist of the user. The watch is operatively connected to the band so as to form a wristwatch. The cell phone is operatively connected to the band.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying drawing.

### 3. BRIEF DESCRIPTION OF THE DRAWINGS

The figures of the drawing are briefly described as follows:

FIG. 1 is a diagrammatic perspective view of the combination watch and cell phone foldable onto each other of the embodiments of the present invention for use around a wrist of a user and in the communicator mode;

FIG. 2 is an enlarged diagrammatic top plan view of the area generally enclosed by the dotted curve identified by ARROW 2 in FIG. 1 of the combination watch and cell phone foldable onto each other of the embodiments of the present invention in the communicator mode;

FIG. 3 is an enlarged diagrammatic perspective view of the area generally enclosed by the dotted curve identified by ARROW 3 in FIG. 1 of the combination watch and cell phone foldable onto each other of the embodiments of the present invention in the time mode;

FIG. 4 is an enlarged diagrammatic top plan view of the area generally enclosed by the dotted curve identified by ARROW 4 in FIG. 1 of the combination watch and cell phone foldable onto each other of the embodiments of the present invention in the communicator mode;

FIG. 5 is an enlarged diagrammatic top plan view of the area generally enclosed by the dotted curve identified by ARROW 5 in FIG. 1 of the combination watch and cell phone foldable onto each other of the embodiments of the present invention in the communicator mode;

FIG. 6 is an enlarged diagrammatic cross sectional view taken along LINE 6-6 in FIG. 5; and

FIG. 7 is an enlarged diagrammatic cross sectional view taken along LINE 7-7 in FIG. 5.

### 4. LIST OF REFERENCE NUMERALS UTILIZED IN THE DRAWING

### A. General.

10 combination watch and cell phone foldable onto each other of embodiments of present invention for use around wrist 12 of user 14
12 wrist of user 14
14 user
   B. Overall Configuration of Combination Watch and Cell Phone Foldable onto each other 10.
16 watch
18 cell phone
20 band for engaging around wrist 12 of user 14
22 apparatus for selectively maintaining watch 16 and cell phone 18 folded against each other and band 20
24 wristwatch
26 static portion of watch 16 and cell phone 18
28 pair of foldable portions of watch 16 and cell phone 18
30 proximal portion of pair of foldable portions 28 of watch 16 and cell phone 18
32 distal portion of pair of foldable portions 28 of watch 16 and cell phone 18
34 keypad of static portion 26 of watch 16 and cell phone 18 for dialing
36 microphone of static portion 26 of watch 16 and cell phone 18 for speaking
38 plurality of function keys of proximal portion 30 of pair of foldable portions 28 of watch 16 and cell phone 18
40 screen of distal portion 32 of pair of foldable portions 28 of watch 16 and cell phone 18
42 watch face/text massager of screen 40 of distal portion 32 of pair of foldable portions 28 of watch 16 and cell phone 18
44 menu of screen 40 of distal portion 32 of pair of foldable portions 28 of watch 16 and cell phone 18
46 speaker of distal portion 32 of pair of foldable portions 28 of watch 16 and cell phone 18 for listening
47 compartment in band 20 for housing batteries 49 for powering combination watch and cell phone 10
49 batteries for powering combination watch and cell phone 10

### C. Specific Configuration of Apparatus 22.

48 pair of detents of apparatus 22
50 pair of balls of apparatus 22
52 springs of apparatus 22

### 5. DETAILED DESCRIPTION OF THE PREFERRED EMBODIMENTS

### A. General.

Referring now to the figures, in which like numerals indicate like parts, and particularly to FIG. 1, which is a diagrammatic perspective view of the combination watch and cell phone foldable onto each other of the embodiments of the present invention for use around a wrist of a user and in the communicator mode, the combination watch and cell phone foldable onto each other of the embodiments of the present invention is shown generally at 10 for use around a wrist 12 of a user 14.

B. The Overall Configuration of the Combination Watch and Cell Phone Foldable onto each other 10.

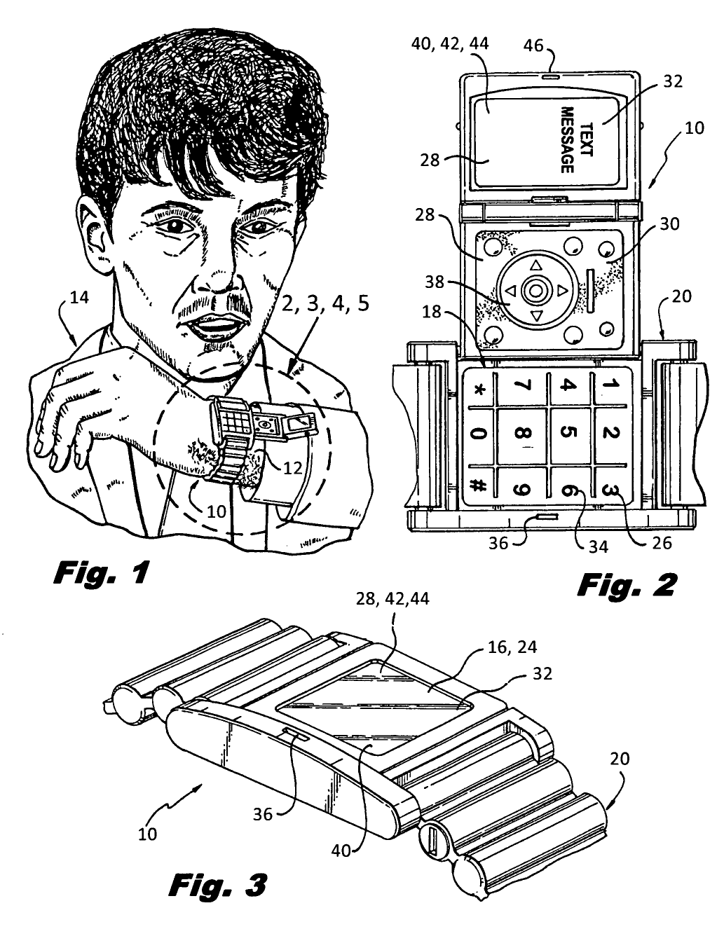

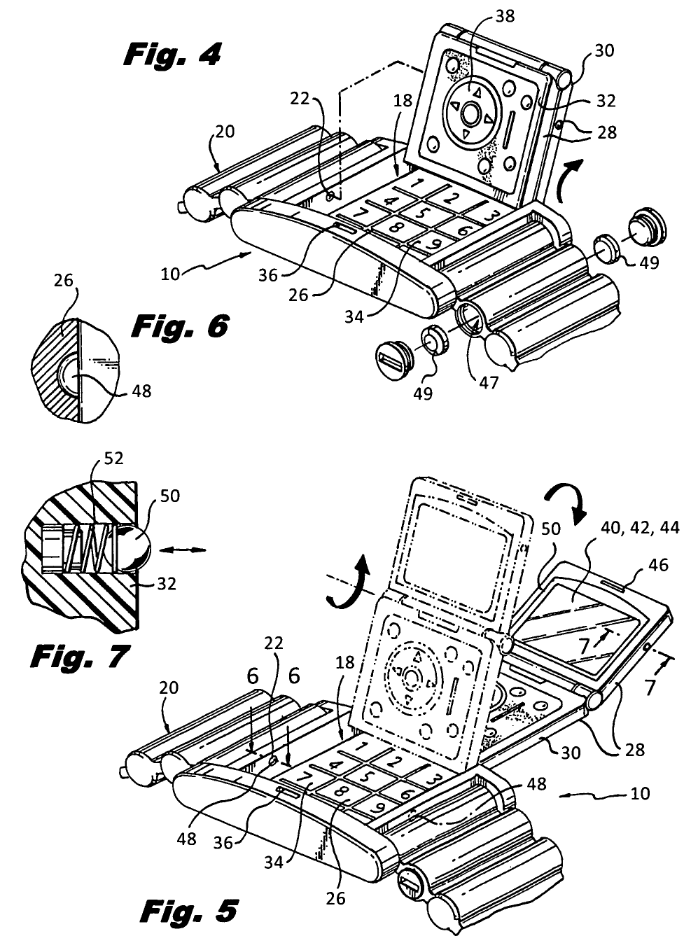

The overall configuration of the combination watch and cell phone foldable onto each other 10 can best be seen in FIGS. 2-5, which are, respectively, an enlarged diagrammatic top plan view of the area generally enclosed by the dotted curve identified by ARROW 2 in FIG. 1 of the combination watch and cell phone foldable onto each other of the embodiments of the present invention in the communicator mode, an enlarged diagrammatic perspective view of the area generally enclosed by the dotted curve identified by ARROW 3 in FIG. 1 of the combination watch and cell phone foldable onto each other of the embodiments of the present invention in the time mode, an enlarged diagrammatic top plan view of the area generally enclosed by the dotted curve identified by ARROW 4 in FIG. 1 of the combination watch and cell phone foldable onto each other of the embodiments of the present invention in the communicator mode, and an enlarged diagrammatic top plan view of the area generally enclosed by the dotted curve identified by ARROW 5 in FIG. 1 of the combination watch and cell phone foldable onto each other of the embodiments of the present invention in the communicator mode, and as such, will be discussed with reference thereto.

The combination watch and cell phone 10 comprises a watch 16, a cell phone 18, a band 20, and apparatus 22 for selectively maintaining the watch 16 and the cell phone 18 folded against each other and the band 20. The band 20 is for engaging around the wrist 12 of the user 14. The watch 16 is operatively connected to the band 20 so as to form a wristwatch 24. The cell phone 18 is operatively connected to the band 20.

The watch 16 and the cell phone 18 comprise a static portion 26. The static portion 26 of the watch 16 and the cell phone 18 forms a part of the band 20.

The watch 16 and the cell phone 18 further comprise a pair of foldable portions 28. The pair of foldable portions 28 of the watch 16 and the cell phone 18 are foldably attached to each other and to the static portion 26 of the watch 16 and the cell phone 18 so as to form a compact structure.

The pair of foldable portions 28 of the watch 16 and the cell phone 18 include a proximal portion 30 and a distal portion 32.

The static portion 26 of the watch 16 and the cell phone 18 comprises a keypad 34. The keypad 34 of the static portion 26 of the watch 16 and the cell phone 18 is for dialing and is programmable for use on either wrist 12 of the user 14.

The keypad 34 of the static portion 26 of the watch 16 and the cell phone 18 can be either mechanical keys or a touch screen.

The static portion 26 of the watch 16 and the cell phone 18 further comprises a microphone 36 for speaking. The microphone 36 of the static portion 26 of the watch 16 and the cell phone 18 is disposed outboard of the keypad 34 of the static portion 26 of the watch 16 and the cell phone 18.

The proximal portion 30 of the pair of foldable portions 28 of the watch 16 and the cell phone 18 is foldably attached to, and selectively overlies, the static portion 26 of the watch 16 and the cell phone 18.

The proximal portion 30 of the pair of foldable portions 28 of the watch 16 and the cell phone 18 comprises a plurality of function keys 38. The plurality of function keys 38 of the proximal portion 30 of the pair of foldable portions 28 of the watch 16 and the cell phone 18 allow navigation through functions of the watch 16 and the cell phone 18.

The distal portion 32 of the pair of foldable portions 28 of the watch 16 and the cell phone 18 is foldably attached to, and selectively overlies, the proximal portion 30 of the pair of foldable portions 28 of the watch 16 and the cell phone 18.

The distal portion 32 of the pair of foldable portions 28 of the watch 16 and the cell phone 18 comprises a screen 40. The screen 40 of the distal portion 32 of the pair of foldable portions 28 of the watch 16 and the cell phone 18 functions both as a watch face/text massager 42 and a menu 44. The menu 44 of the screen 40 of the distal portion 32 of the pair of foldable portions 28 of the watch 16 and the cell phone 18 is navigated through by use of the plurality of function keys 38 of the proximal portion 30 of the pair of foldable portions 28 of the watch 16 and the cell phone 18.

The distal portion 32 of the pair of foldable portions 28 of the watch 16 and the cell phone 18 further comprises a speaker 46 for listening. The speaker 46 of the distal portion 32 of the pair of foldable portions 28 of the watch 16 and the cell phone 18 is disposed outboard of the screen 40 of the distal portion 32 of the pair of foldable portions 28 of the watch 16 and the cell phone 18.

The band 20 comprises a compartment 47. The compartment 47 in the band 20 is for housing batteries 49 for powering the combination watch and cell phone 10.

### C. The Specific Configuration of the Apparatus 22.

The specific configuration of the apparatus 22 can best be seen in FIGS. 5-7, which are, respectively, an enlarged diagrammatic top plan view of the area generally enclosed by the dotted curve identified by ARROW 5 in FIG. 1 of the combination watch and cell phone of the embodiments of the present invention in the communicator mode, an enlarged diagrammatic cross sectional view taken along LINE 6-6 in FIG. 5, and an enlarged diagrammatic cross sectional view taken along LINE 7-7 in FIG. 5, and as such, will be discussed with reference thereto.

The apparatus 22 comprises a pair of detents 48. The pair of detents 48 of the apparatus 22 are disposed opposingly in the static portion 26 of the watch 16 and the cell phone 18, outboard of the keypad 34 of the static portion 26 of the watch 16 and the cell phone 18.

The apparatus 22 further comprises a pair of balls 50. The pair of balls 50 of the apparatus 22 are disposed opposingly in, and biased outwardly by springs 52 from, the distal portion 32 of the pair of foldable portions 28 of the watch 16 and the cell phone 18, outboard of the screen 40 of the distal portion 32 of the pair of foldable portions 28 of the watch 16 and the cell phone 18, and selectively engage in the pair of detents 48 of the apparatus 22.

### D. Conclusions.

It will be understood that each of the elements described above or two or more together may also find a useful application in other types of constructions differing from the types described above.

While the embodiments of the present invention have been illustrated and described as embodied in a combination watch and cell phone foldable onto each other for use around a wrist of a user, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

1. A combination watch and cell phone foldable onto each other for use around a wrist of a user, comprising:
a) a watch;
b) a cell phone;
c) a band; and
d) means for selectively maintaining said watch and said cell phone folded against each other and said band;
wherein said band is for engaging around the wrist of the user;
wherein said watch is operatively connected to said band so as to form a wristwatch; and
wherein said cell phone is operatively connected to said band;
wherein said static portion of said watch and side cell phone forms a part of said band;
wherein said watch and said cell phone comprise a pair of foldable portions;
wherein said pair of foldable portions of said watch and said cell phone are foldable attached to each other and to said static portion of said watch and said cell phone so as to form a compact structure;
wherein said pair of foldable portions of said watch said cell phone include:
A) a proximal portion; and
B) a distal portion
wherein said static portion of said watch and said cell phone comprises a keypad;
wherein said keypad of said static portion of said watch and said cell phone is for dailing; and
wherein said keypad of said static portion of said watch and said cell phone is programmable for use on either wrist of the user.

2. (canceled)

3. (canceled)

4. (canceled)

5. (canceled)

6. (canceled)

7. The combination of claim 1, wherein said keypad of said static portion of said watch and said cell phone is mechanical keys.

8. The combination of claim 1, wherein said keypad of said static portion of said watch and said cell phone is a touch screen.

9. The combination of claim 1, wherein said static portion of said watch and said cell phone comprises a microphone for speaking; and wherein said microphone of said static portion of said watch and said cell phone is disposed outboard of said keypad of said static portion of said watch and said cell phone.

10. The combination of claim 9, wherein said proximal portion of said pair of foldable portions of said watch and said cell phone is foldably attached to said static portion of said watch and said cell phone; and
wherein said proximal portion of said pair of foldable portions of said watch and said cell phone selectively overlies said static portion of said watch and said cell phone.

11. The combination of claim 10, wherein said proximal portion of said pair of foldable portions of said watch and said cell phone comprises a plurality of function keys; and
wherein said plurality of function keys of said proximal portion of said pair of foldable portions of said watch and said cell phone allow navigation through functions of said watch and said cell phone.

12. The combination of claim 11, wherein said distal portion of said pair of foldable portions of said watch and said cell phone is foldably attached to said proximal portion of said pair of foldable portions of said watch and said cell phone; and
wherein said distal portion of said pair of foldable portions of said watch and said cell phone selectively overlies said proximal portion of said pair of foldable portions of said watch and said cell phone.

13. The combination of claim 12, wherein said distal portion of said pair of foldable portions of said watch and said cell phone comprises a screen;
wherein said screen of said distal portion of said pair of foldable portions of said watch and said cell phone functions as a watch face/text messenger; and
wherein said screen of said distal portion of said pair of foldable portions of said watch and said cell phone functions as a menu.

14. The combination of claim 13, wherein said menu of said screen of said distal portion of said pair of foldable portions of said watch and said cell phone is navigated through by use of said plurality of function keys of said proximal portion of said pair of foldable portions of said watch and said cell phone.

15. The combination of claim 14, wherein said distal portion of said pair of foldable portions of said watch and said cell phone comprises a speaker for listening; and
wherein said speaker of said distal portion of said pair of foldable portions of said watch and said cell phone is disposed outboard of said screen of said distal portion of said pair of foldable portions of said watch ad said cell phone.

16. The combination of claim 15, wherein said band comprises a compartment; and
wherein said compartment in said band is for housing batteries for powering said combination watch and cell phone.

17. The combination of claim 16, wherein said means includes a pair of detents; and
wherein said pair of detents of said means are disposed opposingly in said static portion of said watch and said watch and said cell phone, outboard of keypad of said static portion of said watch and said cell phone.

18. The combination of claim 17, wherein said means includes a pair of balls;
wherein said pair of balls of said means are disposed opposingly in said distal portion of said pair of foldable portions of said watch and said cell phone, outboard of said screen of said distal portion of said pair of foldable portions of said watch and said cell phone;
wherein said pair of balls of said means are biased outwardly by springs from said distal portion of said pair of foldable portions of said watch and said cell phone; and
wherein said pair of balls of said means selectively engage in said pair of detents of said apparatus.
